(19) United States
(12) Patent Application Publication
(10) Pub. No.: US 2017/0318532 A1
(43) Pub. Date: Nov. 2, 2017

(54) METHOD FOR TRANSMITTING OR RECEIVING MESSAGES IN A WIRELESS COMMUNICATION SYSTEM AND A DEVICE THEREFOR

(71) Applicant: LG Electronics Inc., Seoul (KR)

(72) Inventor: Seungjune Yi, Seoul (KR)

(21) Appl. No.: 15/464,995

(22) Filed: Mar. 21, 2017

Related U.S. Application Data
(60) Provisional application No. 62/328,022, filed on Apr. 27, 2016.

(51) Int. Cl. H04W 52/02; H04W 76/04; H04W 76/06; H04W 88/02

(52) U.S. Cl. CPC H04W 52/0212; H04W 76/068; H04W 76/046; H04W 88/02

(57) ABSTRACT

The present invention relates to a wireless communication system. More specifically, the present invention relates to a method and a device for transmitting or receiving messages in a wireless communication system, the method comprising: configuring a specific SRB having same configuration as SRB1 without a PDCP entity, and transmitting, using the specific SRB, a first message without applying AS security.

### TECHNICAL FIELD

The present invention relates to a wireless communication system and, more particularly, to a method for transmitting or receiving messages in a wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE

### Technical Problem

An object of the present invention devised to solve the problem lies in a method and device for performing UL packet measurements in a wireless communication system. The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

In order to avoid unnecessary signaling overhead, it is invented that a new signaling radio bearer (SRB) is defined to transmit or receive a message without applying access stratum (AS) security, where the new SRB has same configuration as SRB1 except the PDCP is applied.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

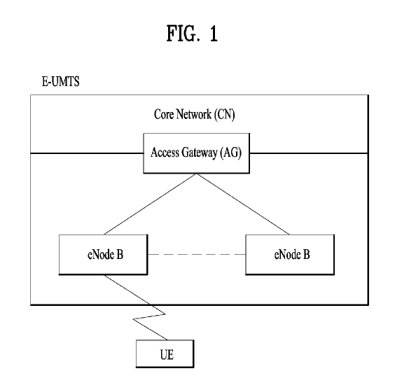

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a view showing an example of a physical channel structure used in an E-UMTS system;

FIG. 4 is a block diagram of a communication apparatus according to an embodiment of the present invention;

FIG. 5 is a diagram showing a control plane and a user plane of a radio interface protocol between a UE and an E-UTRAN based on a 3rd generation partnership project (3GPP) radio access network standard;

FIG. 6 is a diagram for medium access control (MAC) PDU consisting of MAC header, MAC control elements, MAC SDUs and padding;

FIGS. 7A and 7B are examples for MAC PDU subheader structures;

FIG. 8 is a conceptual diagram for a PDCP entity architecture;

FIG. 9 is a conceptual diagram for functional view of a PDCP entity;

FIG. 10 is a diagram for PDCP data PDU format for SRBs;

FIGS. 11A and 11B show exemplary procedures for small data transfer;

FIG. 12 is a conceptual diagram for UE operation regarding a message without AS security according to an exemplary embodiment of the present invention; and

FIG. 13 is a conceptual diagram for UE operation regarding a first message without AS security and a second message with the AS security according to an exemplary embodiment of the present invention.

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

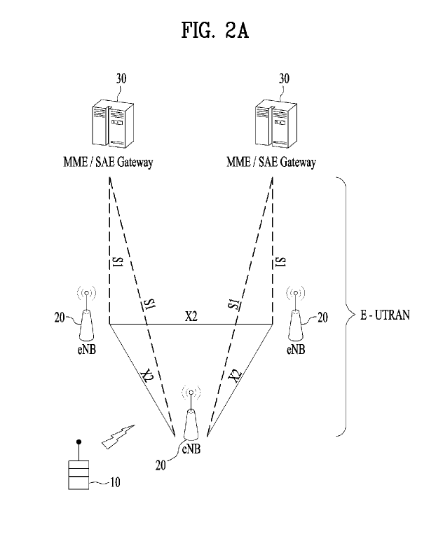

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

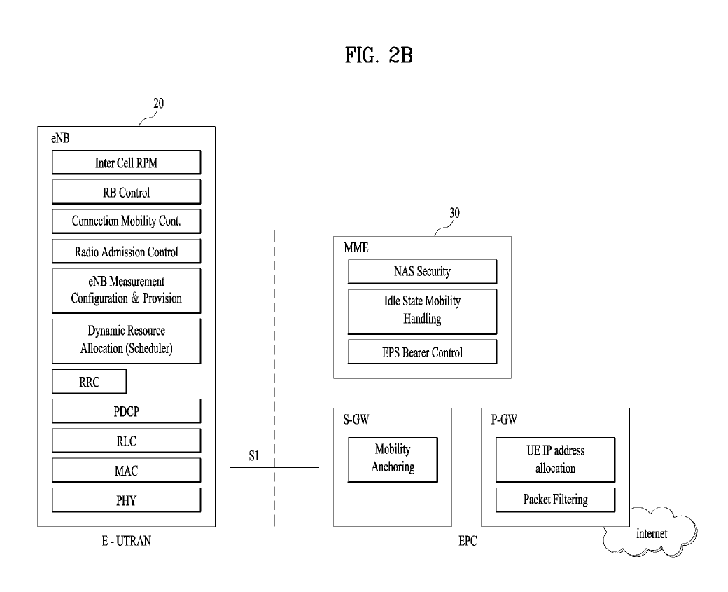

FIG. 3 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 3, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

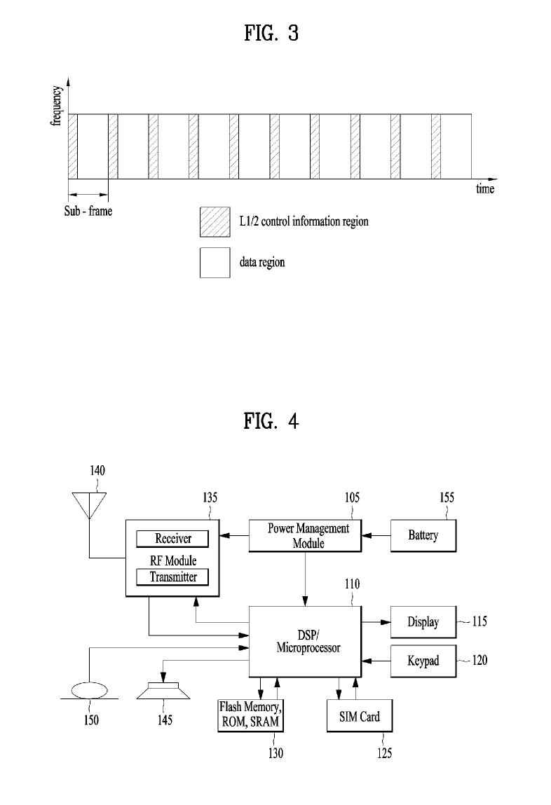

FIG. 4 is a block diagram of a communication apparatus according to an embodiment of the present invention.

The apparatus shown in FIG. 4 can be a user equipment (UE) and/or eNB adapted to perform the above mechanism, but it can be any apparatus for performing the same operation.

As shown in FIG. 4, the apparatus may comprises a DSP/microprocessor (110) and RF module (transceiver; 135). The DSP/microprocessor (110) is electrically connected with the transceiver (135) and controls it. The apparatus may further include power management module (105), battery (155), display (115), keypad (120), SIM card (125), memory device (130), speaker (145) and input device (150), based on its implementation and designer's choice.

Specifically, FIG. 4 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 4 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

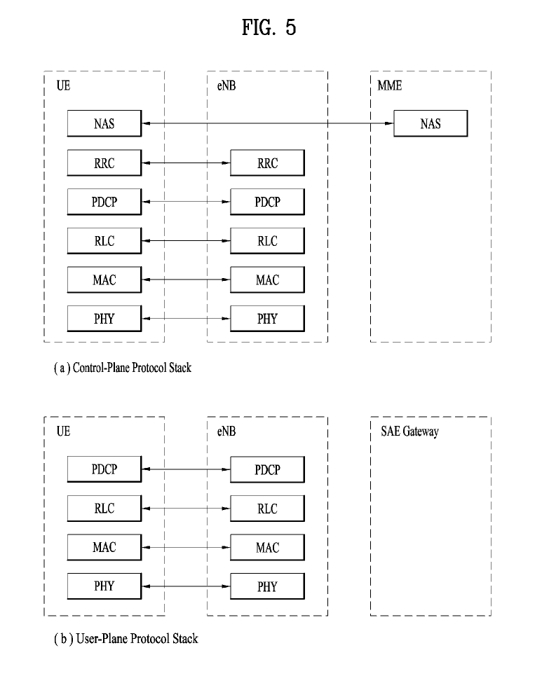

FIG. 5 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

Signaling Radio Bearers (SRBs) are defined as Radio Bearers (RBs) that are used only for the transmission of RRC and NAS messages. More specifically, the following three SRBs are defined: i) SRB0 is for RRC messages using the Common Control Channel (CCCH) logical channel; ii) SRB1 is for RRC messages (which may include a piggybacked NAS message) as well as for NAS messages prior to the establishment of SRB2, all using Dedicated Control Channel (DCCH) logical channel; and iii) SRB2 is for RRC messages which include logged measurement information as well as for NAS messages, all using DCCH logical channel SRB2 has a lower-priority than SRB1 and is always configured by E-UTRAN after security activation.

Once security is activated, all RRC messages on SRB1 and SRB2, including those containing NAS or non-3GPP messages, are integrity protected and ciphered by PDCP. NAS independently applies integrity protection and ciphering to the NAS messages.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

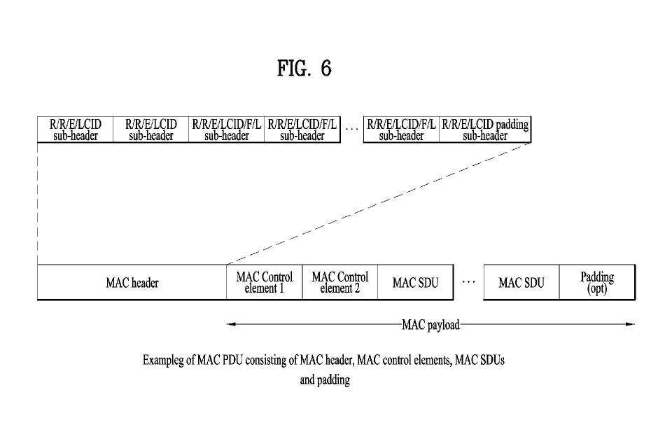

FIG. 6 is a diagram for medium access control (MAC) PDU consisting of MAC header, MAC control elements, MAC SDUs and padding.

To support priority handling, multiple logical channels, where each logical channel has its own RLC entity, can be multiplexed into one transport channel by the MAC layer. At the receiver, the MAC layer handles the corresponding demultiplexing and forwards the RLC PDUs to their respective RLC entity for in-sequence delivery and the other functions handled by the RLC. To support the demultiplexing at the receiver, a MAC header, shown in FIG. 6, is used.

To each RLC PDU, there is an associated sub-header in the MAC header. The sub-header contains the identity of the logical channel (LCID) from which the RLC PDU originated and the length of the PDU in bytes.

A MAC PDU header consists of one or more MAC PDU subheaders; each subheader corresponds to either a MAC SDU, a MAC control element or padding.

MAC PDU subheaders have the same order as the corresponding MAC SDUs, MAC control elements and padding. MAC control elements are always placed before any MAC SDU.

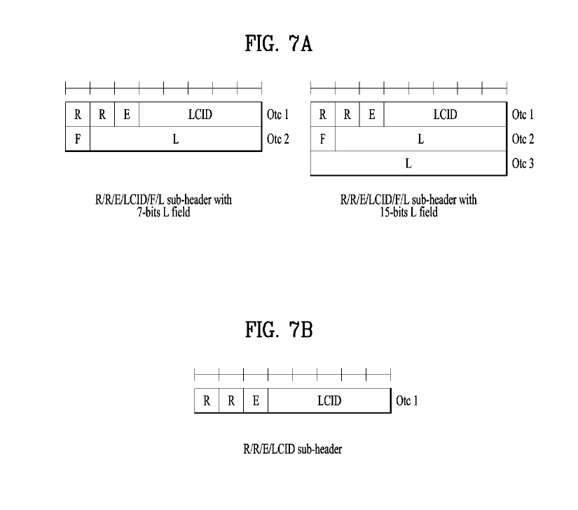

FIGS. 7A and 7B are examples for MAC PDU subheader structures.

A MAC PDU subheader consists of the six header fields R/R/E/LCID/F/L but for the last subheader in the MAC PDU and for fixed sized MAC control elements. The last subheader in the MAC PDU and subheaders for fixed sized MAC control elements consist solely of the four header fields R/R/E/LCID. A MAC PDU subheader corresponding to padding consists of the four header fields R/R/E/LCID.

The MAC header is of variable size and consists of the following fields:

1) LCID: The Logical Channel ID field identifies the logical channel instance of the corresponding MAC SDU or the type of the corresponding MAC control element or padding as described in Tables 1, 2 and 3 for the DL-SCH, UL-SCH and MCH respectively. There is one LCID field for each MAC SDU, MAC control element or padding included in the MAC PDU. In addition to that, one or two additional LCID fields are included in the MAC PDU, when single-byte or two-byte padding is required but cannot be achieved by padding at the end of the MAC PDU. A UE of Category 0 shall indicate CCCH using LCID “01011”, otherwise the UE shall indicate CCCH using LCID “00000”. The LCID field size is 5 bits.

TABLE 1
Values of LCID for DL-SCH

| Index | LCID values |
|---|---|
| 00000 | CCCH |
| 00001-01010 | Identity of the logical channel |
| 01011-11001 | Reserved |
| 11010 | Long DRX Command |
| 11011 | Activation/Deactivation |
| 11100 | UE Contention Resolution Identity |
| 11101 | Timing Advance Command |
| 11110 | DRX Command |
| 11111 | Padding |

TABLE 2
Values of LCID for UL-SCH

| Index | LCID values |
|---|---|
| 00000 | CCCH |
| 00001-01010 | Identity of the logical channel |
| 01011 | CCCH |
| 01100-10101 | Reserved |
| 10110 | Truncated Sidelink BSR |
| 10111 | Sidelink BSR |
| 11000 | Dual Connectivity Power |
| | Headroom Report |
| 11001 | Extended Power Headroom Report |
| 11010 | Power Headroom Report |
| 11011 | C-RNTI |
| 11100 | Truncated BSR |
| 11101 | Short BSR |
| 11110 | Long BSR |
| 11111 | Padding |

TABLE 3
Values of LCID for MCH

| Index | LCID values |
|---|---|
| 00000 | MCCH (see note) |
| 00001-11100 | MTCH |
| 11101 | Reserved |
| 11110 | MCH Scheduling Information or |
| | Extended MCH Scheduling |
| | Information |
| 11111 | Padding |

NOTE:
If there is no MCCH on MCH, an MTCH could use this value.

2) L: The Length field indicates the length of the corresponding MAC SDU or variable-sized MAC control element in bytes. There is one L field per MAC PDU subheader except for the last subheader and subheaders corresponding to fixed-sized MAC control elements. The size of the L field is indicated by the F field.

3) F: The Format field indicates the size of the Length field. There is one F field per MAC PDU subheader except for the last subheader and subheaders corresponding to fixed-sized MAC control elements. The size of the F field is 1 bit. If the size of the MAC SDU or variable-sized MAC control element is less than 128 bytes, the value of the F field is set to 0, otherwise it is set to 1.

4) E: The Extension field is a flag indicating if more fields are present in the MAC header or not. The E field is set to “1” to indicate another set of at least R/R/E/LCID fields. The E field is set to “0” to indicate that either a MAC SDU, a MAC control element or padding starts at the next byte.

5) R: Reserved bit, set to “0”.

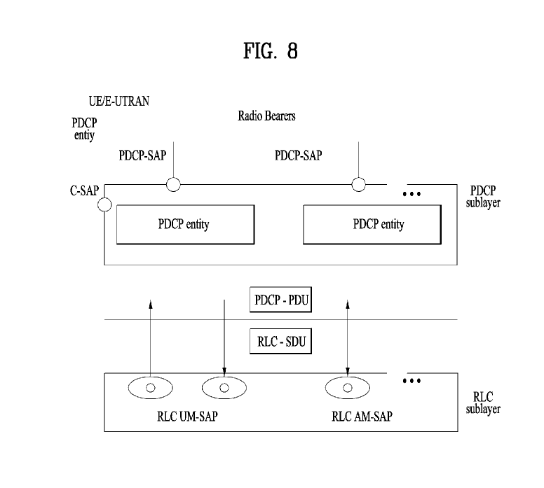

FIG. 8 is a conceptual diagram for a PDCP entity architecture.

FIG. 8 represents one possible structure for the PDCP sublayer, but it should not restrict implementation. Each RB (i.e. DRB and SRB, except for SRB0) is associated with one PDCP entity. Each PDCP entity is associated with one or two (one for each direction) RLC entities depending on the RB characteristic (i.e. unidirectional or bi-directional) and RLC mode. The PDCP entities are located in the PDCP sublayer. The PDCP sublayer is configured by upper layers.

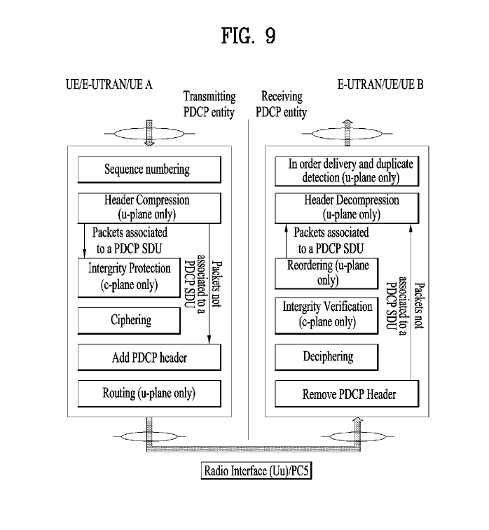

FIG. 9 is a conceptual diagram for functional view of a PDCP entity.

The PDCP entities are located in the PDCP sublayer. Several PDCP entities may be defined for a UE. Each PDCP entity carrying user plane data may be configured to use header compression. Each PDCP entity is carrying the data of one radio bearer. A PDCP entity is associated either to the control plane or the user plane depending on which radio bearer it is carrying data for.

FIG. 9 represents the functional view of the PDCP entity for the PDCP sublayer; it should not restrict implementation. The figure is based on the radio interface protocol architecture.

The PDCP supports the following functions: i) header compression and decompression of IP data flows using the ROHC protocol; ii) transfer of data (user plane or control plane); iii) in-sequence delivery of upper layer PDUs at re-establishment of lower layers; iv) ciphering and deciphering of user plane data and control plane data; and v) integrity protection and integrity verification of control plane data.

PDCP is used for SRBs, DRBs, and SLRBs mapped on DCCH, DTCH, and STCH type of logical channels. PDCP is not used for any other type of logical channels.

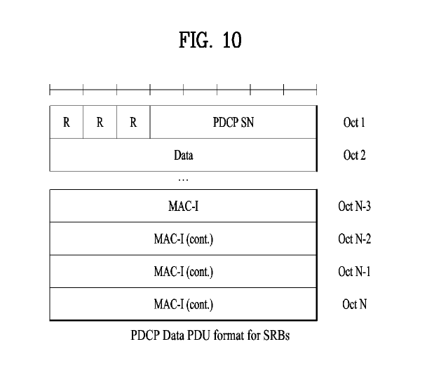

FIG. 10 is a diagram for PDCP data PDU format for SRBs.

A PDCP PDU is a bit string that is byte aligned (i.e. multiple of 8 bits) in length. There may be a various PDCP PDU format, such as i) the format of the PDCP Data PDU carrying data for control plane SRBs; or ii) the format of the PDCP Data PDU carrying data from DRBs. Among them, FIG. 10 shows the format of the PDCP Data PDU carrying data for control plane SRBs.

The PDCP Data PDU is used to convey: i) a PDCP SDU SN, and data including an uncompressed PDCP SDU (user plane data, or control plane data), ii) a compressed PDCP SDU (user plane data only), and iii) a MAC-I field.

The PDCP SN field indicates a sequence number of PDCP SDU. The length of the PDCP SN is 5, 7, 12, 14, 16 or 18 bits as indicated in Table 4.

TABLE 4

| Length | Description |
|---|---|
| 5 | SRBs |
| 7 | DRBs, if configured by upper layers (pdcp-SN-Size [3]) |
| 12 | DRBs, if configured by upper layers (pdcp-SN-Size [3]) |
| 15 | DRBs, if configured by upper layers (pdcp-SN-Size [3]) |
| 16 | SLRBs |
| 18 | DRBs, if configured by upper layers (pdcp-SN-Size [3]) |

The Data field may include either one of i) Uncompressed PDCP SDU (user plane data, or control plane data), or ii) Compressed PDCP SDU (user plane data only).

The Message Authentication Code for Integrity (MAC-I) field carries a message authentication code calculated. The length of the MAC-I is 32-bits. For control plane data that are not integrity protected, the MAC-I field is still present and should be padded with padding bits set to 0.

The R field is reserved. The length of the R field is 1 bit. In this version of the specification reserved bits shall be set to 0. Reserved bits shall be ignored by the receiver.

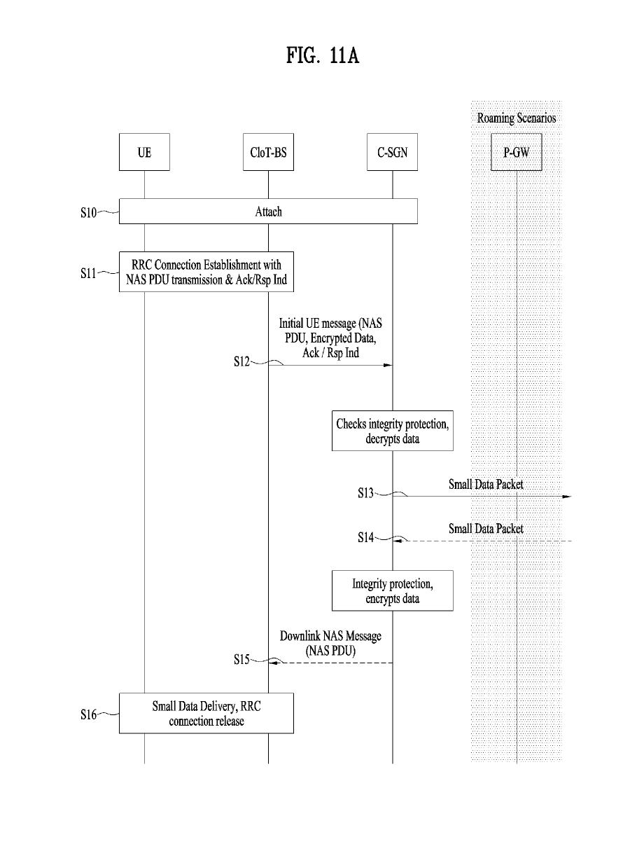

FIGS. 11A and 11B show exemplary procedures for small data transfer.

Recently, for low-end (e.g. low average revenue per user, low data rate, delay tolerant) applications such as Machine-Type Communication (MTC) or Narrow Band-Internet of Things (NB-IoT), a concept of a low complexity UE is introduced.

A low complexity UE indicates UE Category 0 and has reduced transmission and reception capabilities compared to other UE of different categories. A low complexity UE may access a cell only if SIB1 indicates that access of low complexity UEs is supported. If the cell does not support low complexity UEs, a low complexity UE considers the cell as barred.

For the low complexity UE, control plane (CP) solution related to efficient support of infrequent small data transmission has been introduced.

Referring to FIG. 11A, an exemplary procedure for mobile originated (MO) small data transfer and response for the CP solution is described as follows. Descriptions with reference to FIG. 11A is explained with CIoT, but it is also applicable for NB-IoT.

0. The UE performs Attach Procedure.

1. The UE requests the UE's AS to establish an RRC connection. A new NAS message format is used to carry the small data packet (i.e. IP, non-IP, SMS) in an encrypted IE. The UE can also indicate whether acknowledgment/response to the IP packet is expected or not. There is no need to set up DRB and AS security.

2. The CIoT RAN forwards NAS PDU and the indication on whether ack/response is expected to the C-SGN in the initial UE message.

3. The C-SGN decrypts the NAS message, obtaining the small data packet. C-SGN forwards the small data using appropriate mechanism depending on Data Type. For IP small data C-SGN sends it over SGi. For SMS C-SGN sent it to SMS-SC. For non-IP small data C-SGN, based on configuration, sends it to SCEF or to AS using point-to-point IP forwarding tunnel. In roaming case the data traverse through P-GW.

4. If no acknowledgment/response to the small data packet is expected (based on the subscriber information and the Ack/Rsp indication from the UE), the C-SGN immediately releases the connection. Otherwise, when a (response) small data packet arrives in the P-GW, sends it to the C-SGN.

5. The C-SGN encrypts the NAS message with the downlink small data packet and sends the downlink NAS transport message to the CIoT-RAN. C-SGN releases the signalling connection after the timer monitoring the connection expires.

6. CIoT-BS sends the Downlink Information Transfer including the NAS message to UE and also releases the RRC connection after the timer monitoring the connection expires.

Referring to FIG. 11B, an exemplary procedure for mobile terminated (MT) small data transfer for the CP solution is described as follows. Descriptions with reference to FIG. 11B is explained with CIoT, but it is also applicable for NB-IoT.

The case of MT small data transfer uses similar concepts to the case of MO small data transfer described in FIG. 11A.

0. The UE performs Attach Procedure.

1. C-SGN receives small data packet (IP, non-IP, SMS).

2. If there is no signalling connection with the UE, the C-SGN buffers the received small data packet, and pages UE. The UE sends the Service Request message to C-SGN.

3. The C-SGN then sends the small data packet in an encrypted IE in a NAS PDU in a Downlink NAS message and the CIoT-BS sends the NAS PDU onto the UE. There is no need to set up DRB and AS security.

4. The UE might send a packet as an acknowledgement that is sent in an encrypted IE in a NAS PDU in an UL RRC message. The CIoT-BS forwards the NAS PDU to the C-SGN. After the timer monitoring the connection expires, the C-SGN, UE and CIoT-BS release the connection locally.

5. The C-SGN decrypts the NAS-PDU and forward to appropriate node depending on Data Type.

For the CP Solution discussed in FIGS. 11A and 11B, the following assumptions may be applicable: i) LTE UE radio capabilities concept is applicable (i.e. UE can share UE radio capabilities upon network request); ii) An RRC establishment cause is supported. The RRC connection establishment cause can be used for differentiated handling, e.g. of data and signalling, in AS; iii) The RRC Connection is established for small data transfer; iv) at most one NAS signalling message or NAS message carrying small data can be piggybacked in RRCConnectionSetupComplete message in the RRC connection establishment procedure; v) A UL NAS signalling message or UL NAS message carrying small data can be transmitted in a UL RRC container message. A DL NAS signaling or DL NAS small data can be transmitted in a DL RRC container message; vi) DL information transfer and UL information transfer messages are used to carry small data and carried over SRB1; vii) RRC connection reconfiguration is not required for short RRC connections when the connection is used for small data transfer; viii) Data radio bearer (DRB) is not used; ix) There seems to be no need for PDCP; and x) access stratum (AS) security is not needed.

Meanwhile, in legacy LTE system, SRB (except for SRB0) is associated with one PDCP entity (as described with reference to FIG. 6), and PDCP is used for SRBs mapped on DCCH logical channel (as described with reference to FIG. 7). That is, SRB1, which is used for transmitting UE dedicated radio rink control (RRC) message over dedicated control channel (DCCH) always uses PDCP entity, regardless of whether access stratum (AS) security is activated or not.

Further, as described with reference to FIG. 10, for control plane data that are not integrity protected, the MAC-I field is still present and should be padded with padding bits set to 0. The length of the MAC-I is 32 bits (i.e., 4 bytes).

In short, 1 byte PDCP header and 4 bytes MAC-I are always included in a message transmitted or received via SRB1, even if AS security is not applied. Thus 5 bytes header overhead will be caused.

Therefore, the present invention proposes defining a new SRB for NB-IoT UE.

As described above, if the SRB1 is used for CP solution in NB-IoT (i.e. Data over NAS) where the AS security is not applied, 5 bytes overhead are always transmitted without having any gain.

To avoid this unnecessary 5 byte overhead for CP solution, some companies proposed to make the use of PDCP configurable for SRB1. In detail, SRB1 uses PDCP transparent mode (TM) before AS security is activated, and uses legacy PDCP (i.e. PDCP for SRB) when AS security is activated. The SRB1 does not switch back to the PDCP TM as long as the UE stays in RRC connected.

However, making PDCP configurable for SRB1 may have following defects: i) In LTE, one RB has one single L2 configuration. Making PDCP configurable for one RB introduces a new concept for a radio bearer (i.e., SRB1 with PDCP and SRB1 without PDCP); ii) In LTE, the UE cannot change RB configuration without network command. Making the UE to activate or deactivate PDCP depending on the security activation introduces UE autonomous change of RB configuration without network command; and iii) The LCID is the logical channel identifier which identifies a radio bearer. Using LCID to differentiate the existence of PDCP introduces a new concept for LCID (i.e. the LCID is used to identify whether a special L2 configuration is used for a radio bearer).

With above reasons, it should be avoided to make PDCP configurable for the SRB1. If PDCP is not needed for SRB, it is better to define a new SRB.

Defining a new SRB according to the present invention has following benefits: i) No impacts to SRB1 which is used for legacy UE (i.e., SRB1 is still configured using PDCP as legacy to support AS security), thus PDCP can be configured for SRB1 in user plane (UP) solution; ii) Efficient support for simultaneous CP and UP solutions (e.g., No packet-by-packet identification for SRB1 messages whether security is applied or not, and No interaction between PDCP and MAC for LCID attachment); iii) Allow separation of signaling and data for CP solution (e.g., Signaling is transmitted on SRB1, and data is transmitted on the new SRB).

Therefore, the present invention proposes defining new SRB to support “Data over NAS”. The new SRB is same as SRB1 except the PDCP is applied. In other words, the new SRB bypasses the PDCP for CP solution.

Meanwhile, in case that the new SRB is to be used, there is a remaining issue, ‘how the eNB knows that the new SRB is used’.

For this, the present invention proposes allocating a new LCID for the new SRB. The new LCID value is fixed to the new SRB, similar to LCID=1 for SRB1 and LCID=2 for SRB2. For example, the new LCID value can be one of integers from 1 to 10 (values for identity of the logical channel in legacy, see Table 2 above), or one of integers from 12 to 21 (reserved values in legacy, see Table 2 above). In some embodiments, the new LCID value may be 3.

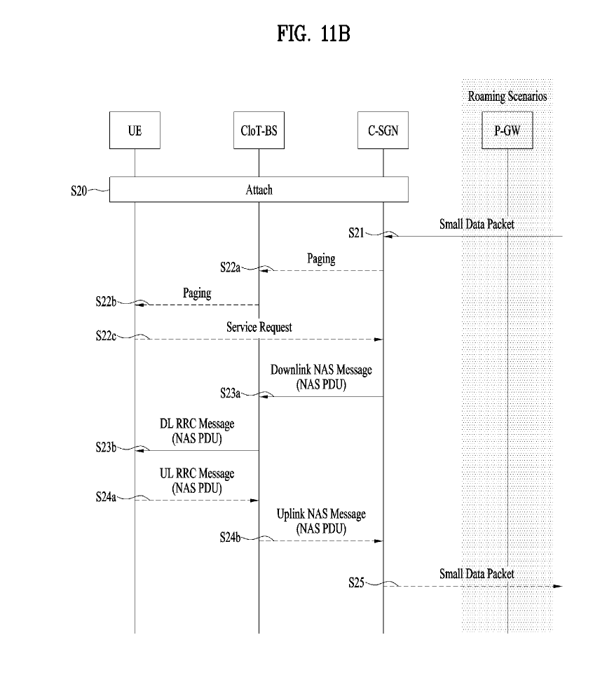

FIG. 12 is a conceptual diagram for UE operation regarding a message without AS security according to an exemplary embodiment of the present invention.

In descriptions with reference to FIG. 12, a UE may be a NB-IoT UE.

Referring to FIG. 12, a UE configures a specific SRB having same configuration as SRB1 without a PDCP entity (S1201). Unlike the SRB1, the specific SRB bypasses the PDCP entity. The SRB1 is a SRB which is used for transmitting UE dedicated RRC message over DCCH.

In some embodiments, the specific SRB is established implicitly with SRB1, during RRC connection establishment procedure. Meanwhile, if the UE is a NB-IoT UE that only supports CP solution, the UE establishes only the specific SRB without establishing the SRB1.

Preferably, the specific SRB is identified by using a specific LCID. For example, a value of the specific LCID is one of integers from 1 to 10 (values for identity of the logical channel in legacy, see Table 2 above), or one of integers from 12 to 21 (reserved values in legacy, see Table 2 above). More specifically, a value of the specific LCID may be 3.

The UE can transmit or receive, using the specific SRB, a first message without applying AS security (S1203). The first message may be a NAS message including data. The first message may be a RRC message or a NAS message prior to activation of security.

If the data included in the NAS message is mobile originated (MO) small data, the UE may transmit the first message using the specific SRB. Or, if the data included in the NAS message is mobile terminated (MT) small data, the UE may receive the first message using the specific SRB.

According to the present embodiments, the first message does not include a PDCP header and MAC-I, because the specific SRB bypasses a PDCP entity.

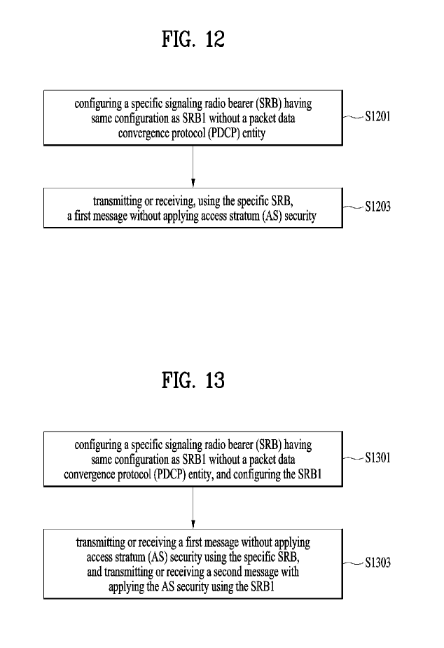

FIG. 13 is a conceptual diagram for UE operation regarding a first message without AS security and a second message with the AS security according to an exemplary embodiment of the present invention.

In descriptions with reference to FIG. 13, a UE may be a NB-IoT UE, but may not be a NB-IoT UE that only supports CP solution.

Referring to FIG. 13, a UE configures SRB1 and a specific SRB having same configuration as the SRB1 without a PDCP entity (S1301).

In some embodiments, the SRB1 and the specific SRB are established during RRC connection establishment procedure.

Preferably, each of the SRB1 and the specific SRB is identified by using LCID. For example, LCID=1 is used for identifying the SRB1, and LCID=3 is used for identifying the specific SRB.

The UE can transmit or receive a first message without applying AS security using the specific SRB, and transmit or receive a second message with applying the AS security using the SRB1 (S1303). Each of the first message and the second message may be a RRC message or a NAS message.

According to the present embodiments, the first message does not include a PDCP header and MAC-I, because the specific SRB bypasses a PDCP entity. In contrast, the second message may include the PDCP header and the MAC-I, because the SRB1 always uses the PDCP entity.

In summary, in the present invention, it is invented that a new SRB is defined to transmit or receive a message without applying AS security, in order to avoid unnecessary signaling overhead. Here, the new SRB has same configuration as SRB1 except the PDCP is applied.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

1. A method for a user equipment (UE) operating in a wireless communication system, the method comprising:
configuring a specific signaling radio bearer (SRB) having same configuration as SRB1 without a packet data convergence protocol (PDCP) entity; and
transmitting, using the specific SRB, a first message without applying access stratum (AS) security.

2. The method according to claim 1,
wherein the SRB1 is a SRB which is used for transmitting UE dedicated radio rink control (RRC) message over dedicated control channel (DCCH).

3. The method according to claim 1, further comprising:
configuring the SRB1, wherein the SRB1 uses the PDCP entity; and
transmitting, using the SRB1, a second message with applying the AS security.

4. The method according to claim 1,
wherein the first message is a non-access stratum (NAS) message including data.

5. The method according to claim 1,
wherein each of the first message and the second message is a RRC message or a NAS message.

6. The method according to claim 1,
wherein the first message does not include a PDCP header and message authentication code for integrity (MAC-I).

7. The method according to claim 1,
wherein the specific SRB is identified by using a specific logical channel identity (LCID).

8. The method according to claim 7,
wherein a value of the specific LCID is 3.

9. The method according to claim 1,
wherein the UE is a narrow band internet of things (NB-IoT) UE.

10. A User Equipment (UE) for operating in a wireless communication system, the UE comprising:
a Radio Frequency (RF) module; and
a processor operably coupled with the RF module and configured to:
configure a specific signaling radio bearer (SRB) having same configuration as SRB1 without a packet data convergence protocol (PDCP) entity, and
transmit, using the specific SRB, a first message without applying access stratum (AS) security.

11. The UE according to claim 10,
wherein the SRB1 is a SRB which is used for transmitting UE dedicated radio rink control (RRC) message over dedicated control channel (DCCH).

12. The UE according to claim 10, wherein the processor is further configured to:
configure the SRB1, wherein the SRB 1 uses the PDCP entity, and
transmit, using the SRB1, a second message with applying the AS security.

13. The UE according to claim 10,
wherein the first message is a non-access stratum (NAS) message including data.

14. The UE according to claim 10,
wherein each of the first message and the second message is a RRC message or a NAS message.

15. The UE according to claim 10,
wherein the first message does not include a PDCP header and message authentication code for integrity (MAC-I).

16. The UE according to claim 10,
wherein the specific SRB is identified by using a specific logical channel identity (LCID).

17. The UE according to claim 16,
wherein a value of the specific LCID is 3.

18. The UE according to claim 10,
wherein the UE is a narrow band internet of things (NB-IoT) UE.

19. A method for a user equipment (UE) operating in a wireless communication system, the method comprising:
configuring a specific signaling radio bearer (SRB) having same configuration as SRB1 without a packet data convergence protocol (PDCP) entity; and
receiving, using the specific SRB, a first message without applying access stratum (AS) security.

20. The method according to claim 19, further comprising:
configuring the SRB1, wherein the SRB 1 uses the PDCP entity; and
receiving, using the SRB1, a second message with applying the AS security.
